(19) United States
(12) Patent Application Publication
(10) Pub. No.: US 2005/0150667 A1
(43) Pub. Date: Jul. 14, 2005

(54) Bit holder for a ploughing bit and ploughing bit

(75) Inventors: Uwe Tillessen, Kamen (DE); Norbert Hesse, Bochum (DE); Gerhard Siepenkort, Lunen (DE); Klaus Duhnke, Bochum (DE); Adam Klabisch, Dortmund (DE)

Correspondence Address: Erik J. Overberger, Esq.;Fay, Sharpe, Fagan, Minnich & McKee, LLP, Seventh Floor, 1100 Superior Avenue, Cleveland, OH, 44114-2518, US

(73) Assignee: DBT GmbH

(21) Appl. No.: 11/000,275

(22) Filed: Nov. 30, 2004

(30) Foreign Application Priority Data
Dec. 29, 2003 (DE) 203 20 163.9

(51) Int. Cl. B26D 1/00

(52) U.S. Cl. 172/272

(57) ABSTRACT

The invention relates to a bit holder for a ploughing bit of a coal or extraction plough, with an insert pocket open on the top side for receiving a bit shank formed on the ploughing bit. The pocket is bounded by two lateral supporting walls, a front and a rear supporting wall, whereby the rear supporting wall has an elevated section projecting over the adjoining, lateral supporting walls. The rear supporting wall forming a bit support for the ploughing bit slopes down to its outer regions. In order to allow a good support for an inserted bit and easy and fast installation of the bit the front face of the rear supporting wall is fitted on the outer regions with guiding surfaces sloping down inwards to the insert pocket as an installation aid for the ploughing bit.

The invention relates to a bit holder for a ploughing bit of a coal or extraction plough, with an insert pocket open on the top face for reception of a bit shank formed on the ploughing bit, which is bounded by two lateral supporting walls, a front and a rear supporting wall, whereby the rear supporting wall exhibits an elevated section that projects above the adjacent side supporting walls, forms a bit support for the ploughing bit, is arranged primarily or essentially in the central region of the rear supporting wall, and slopes down to its outer regions.

In the bit holder known from DE-U 298 03 944, the elevated section supporting the back face of the ploughing bit projects only a short distance above the lateral supporting walls and therefore offers only slightly better support for the bit than a bit holder in which all four supporting walls are approximately the same height. The slightly better support of the bit provided by the higher rear supporting wall is generally associated with the disadvantage that coal dust can be deposited and compacted in the region of the rear supporting wall, as a result of which it is far more difficult to dismantle the bit. The reason for the increased accumulation of coal dust in the region of the higher rear supporting wall lies in the fact that the elevated section in the case of bit holders of known art is provided over practically its whole width and as a result a kind of gusset-type fillet groove is formed at the side near the inserted bit between the lateral supporting walls and the outer higher regions of the rear supporting wall, in which the fine coal can easily be deposited.

In order to avoid the disadvantages of an undesired deposit of fine coal in the transition region between the lateral supporting walls and the rear supporting wall it is proposed in the generic DE 299 01 985 to form the elevated section only in the central region of the rear supporting wall, whereby the rear supporting wall is then to slope down to its outer regions, as a result of which the front of the rear supporting wall, facing the ploughing bit and the insert pocket, exhibits in the outer regions deflectors that slope down and run outwards in the opposite direction to the work flow of the ploughing bit. As the elevated section forming the bit support only projects slightly at the side above the inserted ploughing bit, there is no significant dead space between the ploughing bit, the lateral supporting walls and the outer regions of the rear supporting wall. In addition, the deflectors aligned diagonally against the work flow direction of the ploughing bit are to ensure that fine coal that is blown against the work flow direction of the ploughing bit from its bit tip in the direction of the rear supporting wall, is guided diagonally outwards.

The generic bit holder reduces the tendency for fine coal to collect in the gusset, however, the installation of a new bit, e.g. in the event of replacement of all or individual ploughing bits as required by wear and tear, is made considerably more difficult as a result of the configuration with the outward-directed deflectors, extending almost as far as the insert pocket.

The object of the invention is to create a bit holder that allows good support for an inserted bit and easy and fast installation of the bit.

This object is achieved with the invention, in that the front wall facing the insert pocket of the rear supporting wall is fitted with guiding surfaces that slope down inwards diagonally to the insert pocket in the outer regions as an installation aid for the ploughing bit. The guiding surfaces that slope down to the insert pocket ease the insertion of the ploughing bit considerably, as even a bit that is introduced slightly tilted is aligned relative to the insert pocket as a result of the guiding surfaces. The front wall still serves as a rearward support for the ploughing bit. At the same time the guiding surfaces can also act to deflect the fine coal away from the insert pocket.

In a preferred embodiment the lateral supporting walls can be configured level on their upper top faces essentially over the whole thickness and/or configured as sloping diagonals to the longitudinal centre plane of the insert pocket. Preferably both top faces here run relative to the longitudinal centre plane with a slope angle of around 93°. This alignment of the top faces of the lateral supporting walls improves the support of the bit inserted in the insert pocket as the bit with its bit head can lean or support itself against a large area of the top faces on both sides of the insert pocket. In addition, an undesired dead space between the bit head or bit shank and the bit holder is avoided and deflection of fine coal is achieved. In another preferred embodiment the guiding surfaces can extend above and partially also below the top faces of the lateral supporting walls in order to ensure that the ploughing bit is inserted with its bit shank under the height of the top faces.

For a beneficial bit support the front supporting wall can be fitted at the transition to the top faces of the lateral supporting walls with a supporting projection for the bit head of the ploughing bit, whereby the frontal area of the supporting projection is preferably fitted with a V-shaped recess in order to secure the bit head laterally also. The outer regions of the front face of the rear supporting wall can also preferably be arched to from a trough from the vertex of the elevated section to the top faces in the guiding surfaces and in the bounding surfaces that connect to the outer regions. The deflection of coal is further improved if for the bit holder in accordance with the invention the edges slope backwards to the lateral supporting walls, thus—as for bit holders of like kind—forming narrow deflectors aligned diagonally against the work flow direction of the plough that deflect the fine coal diagonally outwards. The narrow edges can in the extreme case be formed exclusively from the round transition sections beneficial for the manufacture by casting of a cast bit holder.

In alignment with the loads to which a bit holder is exposed during operation the latter preferably has as applicable an only slightly pronounced asymmetry of configuration of the lateral supporting walls and the outer regions of the rear supporting wall relative to the longitudinal centre plane of the insert pocket. It is expedient if the bit support formed by the rear supporting wall in its central maximum raised region, has a width that corresponds approximately with the width of the insert pocket. Thus the rear supporting wall in its central region is, at least near the preferably arched vertex of the rear supporting wall, either not or at the most slightly wider than the ploughing bit inserted in the insert pocket and the outer regions do not have to be configured over the whole height of the elevated section formed by the rear supporting wall, but in the preferred construction of the invention, are present only where the rear, elevated supporting wall section projects laterally over the inserted bit or the insert pocket, thus in the transition region to the lateral supporting walls.

Other features and benefits of the invention can be seen from the following description and the drawing, in which a preferred embodiment of the invention is explained in more detail. It shows:

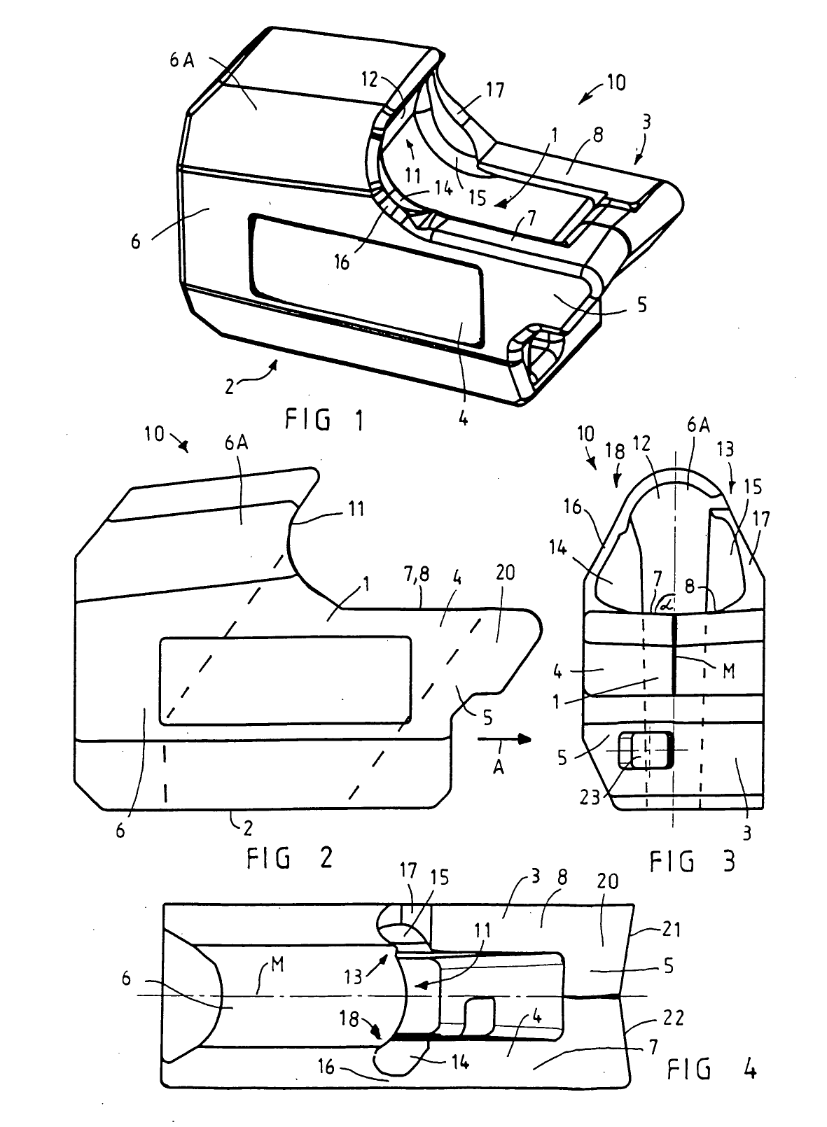

FIG. 1 a representation in perspective of the bit holder in accordance with the invention;

FIG. 2 a side view of the bit holder in accordance with FIG. 1;

FIG. 3 a front view of the bit holder in accordance with FIG. 1; and

FIG. 4 a plan view of the bit holder in accordance with FIG. 1.

A bit holder is denoted in the drawing with reference symbol 10 for a coal plough, of which no further details are shown, into whose insert pocket 1, open at least on the top face, a ploughing bit that is not shown can be inserted with its bit shank and anchored using suitable means for securing bits. Two lateral supporting walls 3, 4, a front supporting wall 5 and a rear supporting wall 6 project from the underside 2 of the bit holder 10 that enclose the edges of the insert pocket 1, as can in particular be seen from FIGS. 2 and 3 in which the position of the insert pocket 1 is denoted by dashed lines. The insert pocket 1 slopes diagonally to the back on its front and rear bounding surfaces formed by the supporting walls 4, 5 at an angle of inclination of approximately 55° relative to the ploughing work flow direction indicated in FIG. 2 by the arrow A. The lateral bounding surfaces of the insert pocket 1 formed by the lateral supporting walls 3,4 diverge by a small sloping angle of around 1.8° relative to the longitudinal centre plane M of the insert pocket 1 so that the insert pocket widens slightly in a wedge-shaped manner from the underside 2 upwards in order to achieve a beneficial anchoring by shape of the correspondingly adapted bit shank that can be inserted into the insert pocket 1.

As can be clearly seen from the Figures, the rear supporting wall 6 projects above the top faces 7, 8 of both lateral supporting walls 3,4 and the front supporting wall 5 by approximately 1/3 of their total height with a rear supporting wall section 6A. The supporting wall section 6A therefore forms an elevated section, whose front face 11 pointing in the ploughing work flow direction A and facing the insert pocket 1 provides an additional rear support for the back of a ploughing bit inserted into the bit holder 10. The front face 11 is arched to form a trough, as can especially be clearly seen in FIG. 2. The front face 11 of the supporting wall section that is the elevated section 6A has a central region 12, which extends across the width of the insert pocket 1, and two outer regions 13, 18, which lie above the top faces 7, 8 of the lateral supporting walls 3, 4 respectively, and which are fitted with guiding surfaces 14, 15 respectively that slope downwards and slant inwards towards the insert pocket 1. These guiding surfaces 14, 15 serve as an installation aid in the guidance of the bit shank into the insert pocket 1 during installation of the bit, and they also run partially below the top faces 7, 8. The two edge regions 16, 17 that adjoin the guiding surfaces respectively at the side, i.e. at the transition to the lateral supporting walls 3, 4, slope laterally towards the back and thus form lateral guiding surfaces for the deflection of fine coal. As can be seen clearly from FIGS. 3 and 4 the guiding surfaces 14, 15 differ slightly in configuration so that the complete bit holder 10 is configured asymmetrically with respect to the longitudinal centre plane M. Furthermore, the configuration is such that the elevated section 6A forming the actual bit support is configured primarily in the central region of the rear supporting wall 6 over a width that approximately corresponds with the width of the insert pocket.

Both top faces 7, 8 are inclined by approximately 3° from outside to inside of the insert pocket 1 as slopes so that the sloping angle α with the longitudinal centre plane li is approximately 93°. A supporting projection 20 is arranged to provide front face support for a ploughing bit at the transition of the top faces 7, 8 into the front supporting wall 5. The front faces 21, 22 of the supporting projection 20 slope backwards by approximately the same sloping angle as the front and rear bounding surfaces of the insert pocket and they run together at an obtuse angle of around 170°. In this way a V-shaped recess is formed that can support the ploughing bit head (not shown) laterally. The supporting projection 20 projects far above an opening 23 in the front supporting wall 5 so that a bolt head of a bit securing bolt in the bit insert can fit protected in the outer face of the front supporting wall 5.

By means of the elevated section 6A of the bit support compared with the other supporting walls 3, 4, 5 a ploughing bit inserted in the insert pocket 1 has a particularly large contact surface as a result of which the surface pressures in this region, which is exposed to the most load, are always comparably low and as a result of which also the life of the bit and the bit holder is improved compared with bit configurations of known art. The forces exercised on the bit holder by the ploughing bit when the plough is in operation can be absorbed very well by the bit holder via the projecting, rear support surface and in particular the moments exercised by the bit are well absorbed by the bit holder, since as a result of the larger support surface separations compared with state-of-the-art technology the loads resulting from the moments are lower. As a result of the slim, high bit support only in the centre of the supporting wall section 6A of the rear supporting wall 6 the entry, retention and compaction of fine coal is reliably prevented in this region of the bit configuration.

1. Bit holder for a ploughing bit of a coal or extraction plough comprising: an insert pocket open on the top side for receiving a bit shank formed on the ploughing bit, which on edges thereof is bounded by two lateral supporting walls, and a front and a rear supporting wall, whereby the rear supporting wall has an elevated section projecting over the adjoining, lateral supporting walls, which rear supporting wall forms a bit support for the ploughing bit, is primarily configured in the center of the rear supporting wall and slopes down to outer regions thereof, wherein a front face of the rear supporting wall facing the insert pocket is fitted on the outer regions with guiding surfaces sloping down inwards to the insert pocket as an installation aid for the ploughing bit.

2. Bit holder in accordance with claim 1, wherein the lateral supporting walls are configured as level on their respective upper top faces essentially over their whole thickness and/or are configured as slopes slanting down to a longitudinal center plane of the insert pocket.

3. Bit holder in accordance with claim 2, wherein both top faces run relative to the longitudinal center plane with a slope angle of approximately 930.

4. Bit holder in accordance with claim 2, wherein the guiding surfaces extend above and partially also below the top faces of the lateral supporting walls.

5. Bit holder in accordance with claim 1, wherein the front supporting wall is fitted on a transition to the top faces of the lateral supporting walls with a supporting projection for a bit head of a ploughing bit, whereby the front face of the supporting projection is fitted with a V-shaped recess.

6. Bit holder in accordance with claim 1, wherein the outer regions of the front face of the rear supporting wall are arched to form a trough from a vertex of the elevated section to top faces in the guiding surfaces and in bounding surfaces that connect to the outer regions.

7. Bit holder in accordance with ene of the claim 1, wherein bounding surfaces slope down backwards to the lateral supporting walls.

8. Bit holder in accordance with claim 1, having an asymmetrical configuration of the lateral supporting walls and the outer regions of the rear supporting wall relative to the longitudinal center plane of the insert pocket.
